(19) United States
(12) Patent Application Publication
(10) Pub. No.: US 2002/0058121 A1
(43) Pub. Date: May 16, 2002

(54) Tubular liner and method of rehabilitating of conduits

(75) Inventor: Mario Mercier, Anjou (CA)

Correspondence Address: COLLARD & ROE, P.C., 1077 Northern Boulevard, Roslyn, NY, 11576-1696, US

(73) Assignee: SANEXEN Environmental Services Inc.

(21) Appl. No.: 09/992,265

(22) Filed: Nov. 13, 2001

(30) Foreign Application Priority Data
Nov. 14, 2000 (CA) 2,325,891

(51) Int. Cl. B32B 1/08

(52) U.S. Cl. 428/94; 428/36.91; 156/94

(57) ABSTRACT

A tubular liner and a method for the rehabilitation of damaged conduits are disclosed. This tubular liner has unbound concentric outer and inner tubular jackets made of a flexible material capable of being impregnated with a curable adhesive resin. The tubular liner also has an impermeable film made of a material impermeable to liquid, bonded to an inner surface of the inner jacket. Therefore, the proposed method for rehabilitating a damaged conduit comprises the steps of:

a) providing the above mentioned tubular liner;

b) injecting a curable adhesive resin between the two tubular jackets:

c) impregnating the curable adhesive resin into the tubular jackets;

d) inserting the tubular liner into the conduit;

e) shaping the tubular liner to conform to the inner wall of the conduit; and

f) heating the curable adhesive resin for rigidifying the tubular liner.

### FIELD OF THE INVENTION

The present invention relates generally to the rehabilitation of underground conduits. More specifically, the present invention relates to a tubular liner for covering the inner wall of a conduit. The invention is suitable for rehabilitating, for example, damaged potable water piping or watermains.

### BACKGROUND OF THE INVENTION

Known in the art are the cured-in-place piping used mostly for sewers. These cured-in-place pipings have limited use for the rehabilitation of watermains because of their high cost and their limited performance in pressurized service. An example of such cured-in-place piping is shown in U.S. Pat. 5,384,086.

Also known in the art are the spray-on linings, and/or pig applied linings (with cement mortar or a resin such as an epoxy resin). In their usual application, these systems provide corrosion protection but do not provide a new structural watertight pipe. Also, the use of multiple layers to provide a structural watertight wall requires a curing period between the application of each layer, which is a serious disadvantage with respect to cost and time.

Further known in the art is the insertion of a polyethylene semi-flexible pipe that is deformed prior to insertion and reformed after insertion. The major disadvantage of this method is that an excavation is required to re-establish the service at each lateral connection. Another disadvantage is the contraction property of polyethylene that are greater than those of cured in place piping and that can lead to damage to the integrity and tightness of the new pipe, especially at lateral connections, such as Mueller valves.

Lining products and lining methods presently used for the rehabilitation of underground conduits have resulted to the advancement within the present field. However, important problems in this area continue to persist, specifically concerning the rehabilitation of watermains. These problems arise from the fact that the lining products known in the prior art fail to provide all the desired characteristics, namely watertightness, innocuousness, ease of installation, structural construction, avoidance of excavation at the corporation stops, and overall cost-effectiveness.

Therefore, there is still a need for an improved tubular liner for the rehabilitation of underground conduits, specifically watermains.

### SUMMARY OF THE INVENTION

It is therefore an object of the present invention to provide an improved tubular liner for covering the inner surface of an underground conduit.

In accordance with the invention, that object is achieved with a tubular liner for covering an inner wall of a conduit, the liner comprising:

at least two concentric tubular jackets made of a flexible material capable of being impregnated with a curable adhesive resin, said at least two tubular jackets including an outer jacket and an inner jacket; and

an impermeable film made of a material impermeable to liquid, bonded to an inner surface of the inner jacket.

The present invention is also directed to a rehabilitated conduit comprising:

a tubular conduit with an inner wall; and

a liner covering the inner wall of the conduit, the liner comprising:

at least two concentric tubular jackets impregnated with a curable adhesive resin, the at least two jackets being bonded to each other and including an outer jacket and an inner jacket; and

an impermeable film made of a material impermeable to liquid, bonded to an inner surface of the inner jacket.

The present invention also proposes a method of rehabilitating a tubular conduit having an inner wall, the method comprising the steps of:

a) providing a tubular liner as defined above;

b) injecting a curable adhesive resin between the at least two tubular jackets;

c) impregnating a curable adhesive resin into the tubular jackets;

d) inserting the tubular liner of step c) into the conduit;

e) shaping the tubular liner to conform to the inner wall of the conduit; and

f) heating the thermosetting adhesive for rigidifying the tubular liner.

A tubular liner for rehabilitating a conduit and its method thereof of the present invention propose innovative features which make the installation of the tubular liner into the damaged conduit more rapid and reliable and offer an overall cost-effectiveness over those of the prior art. More particularly, the method of the present invention eliminates almost any air bubbles during the impregnation of the adhesive into the jackets of the tubular liner that would diminish the mechanical performance of the same.

### BRIEF DESCRIPTION OF THE DRAWINGS

The present invention and its advantages will be more easily understood after reading the following non-restrictive description of a preferred embodiment thereof, made with reference to the following drawings wherein:

FIG. 1 is a partially broken away perspective view of a conduit rehabilitated with a tubular liner according to a preferred embodiment of the invention.

FIG. 2 is a cross-sectional view of a tubular liner of the present invention, showing the injection of the curable adhesive resin between the tubular jackets.

FIG. 3 is a schematic side view of a conduit before its rehabilitation with a tubular liner according to the invention.

FIG. 4 is the same view as FIG. 3 illustrating the insertion of the tubular liner into the conduit.

FIG. 5 is a perspective view representing the tubular liner of FIG. 2 being compressed between compression rollers for impregnating the curable adhesive resin into the tubular jackets.

FIG. 6 is an enlarged cross-sectional view taken on the plane indicated A-A of FIG. 5.

FIG. 7 is a general schematic view illustrating method steps performed on the liner before insertion of the same into the conduit.

FIG. 8 is the same view as in FIGS. 3 and 4, showing the step of shaping the tubular liner to its cylindrical form.

FIG. 9 is the same view as in FIGS. 3 and 4, showing the tubular liner of FIG. 2 covering the inner wall of the conduit.

### DESCRIPTION OF A PREFERRED EMBODIMENT

The present invention is directed to a tubular liner for covering an inner wall of a conduit.

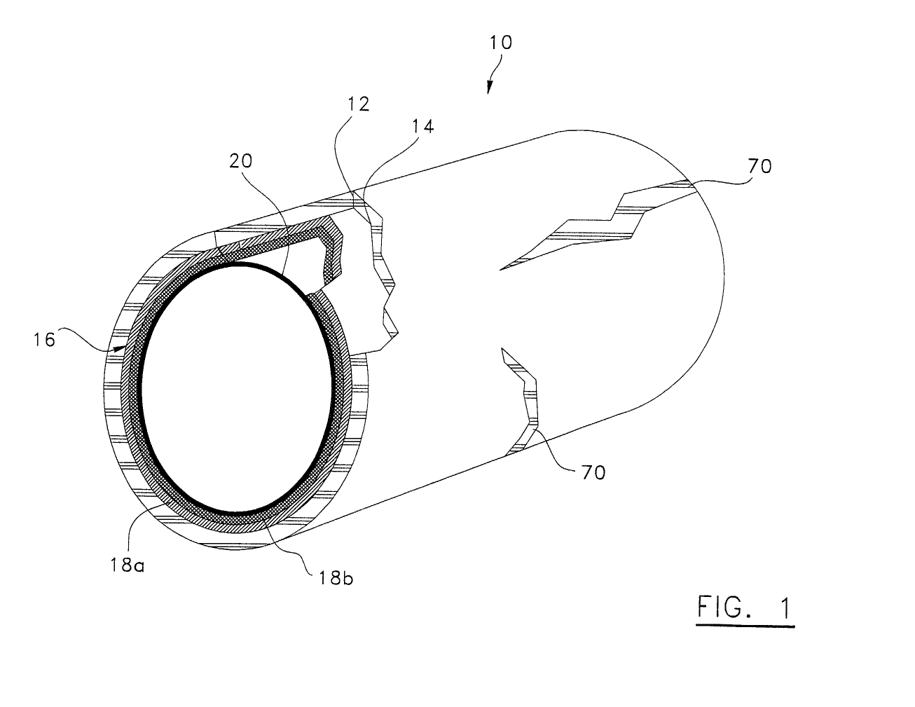

Referring to FIG. 1, a rehabilitated conduit 10 according to the present invention is shown. The rehabilitated conduit 10 consist of a tubular conduit 12 having its inner wall 14 covered with a tubular liner 16 of the present invention. It will be understood that such a tubular liner may be used to cover the inner wall of a variety of damaged conduits. However, it is particularly suitable for covering the interior wall of a damaged water conduit, such as potable water pipings or watermains. By “covering the inner wall of the conduit” as that term is used therein, it is meant covering through the provision of a hardened tubular liner which snugly fits inside the damaged conduit and/or by the bonding of the hardened tubular liner to the conduit's inner wall. It will be also understood that the term “damaged conduit” refers to a conduit that has structural or physical anomalies, such as cracks 70, that cause the conduit to leak, or to eventually break upon further stresses.

The rehabilitated conduit shown in FIG. 1 is obtained by rehabilitating a damaged conduit according to the proposed method of the present invention, which will be discussed in detail hereinafter.

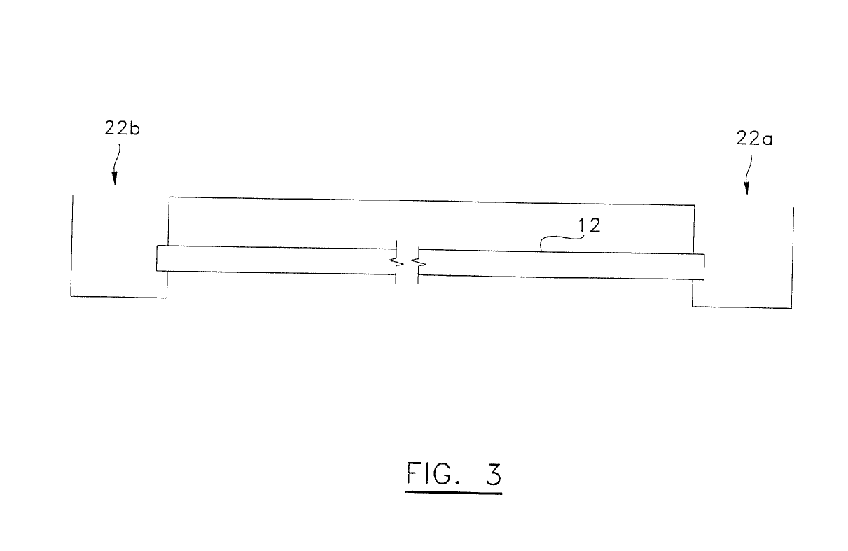

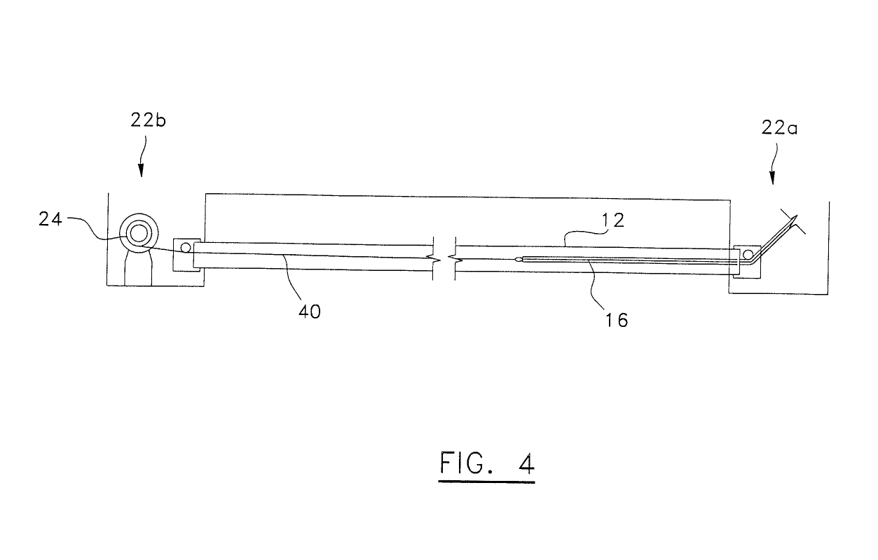

Prior to rehabilitating the damaged conduit 12 also called hereinafter a host conduit 12, a segment of the same is preferably prepared for the insertion of the tubular liner 16 thereon. As shown in FIG. 3, two access pits 22a, 22b are located at each end of the host conduit 12. The distance between the access pits 22a, 22b (for example, 100 meters which is approximately the distance between fire hydrants) will determine the length of the segment of the conduit 12 to be rehabilitated. The access pits 22a, 22b may be already existing as valve chambers or manholes. If the access pits 22a, 22b are not available, then they are excavated. In such a case, the excavation area will preferably have a surface of approximately 2 meter wide by 3 meter long. The two access pits 22a, 22b serve a function of entry point 22a and exit point 22b as demonstrated in FIG. 3. The tubular liner 16 will be inserted from the entry point 22a in the host conduit 12. A pulley 24 is located at exit point 22b for pulling the tubular liner 16 in the host conduit 12, as also shown in FIG. 4.

Also prior to rehabilitating the damaged conduit 12, the latter is preferably cleaned and reamed to smooth the surface and remove accumulated scale and tuberculation which may be caused by rust.

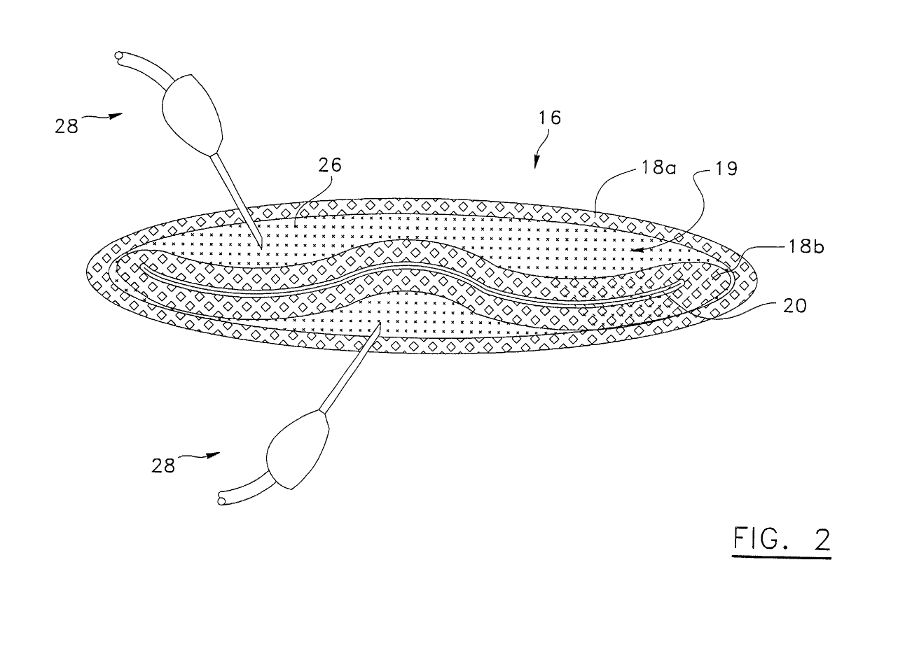

Referring now to FIG. 2, the tubular liner 16 according to a preferred embodiment of the invention comprises two concentric tubular jackets 18a, 18b made of a flexible material capable of being impregnated with a curable adhesive resin.

The tubular jackets 18a, 18b include an outer jacket 18a and an inner jacket 18b, both preferably made of a woven textile whose material may advantageously be a synthetic polymeric fiber selected from the group consisting of polyester fiber, glass fiber or carbonaceous fiber. Most preferably, the tubular jackets 18a, 18b are seamless tubular jackets of woven textile. The preferred woven textile is advantageously designed with a yarn density of about 1.1807 kg/m² for allowing an adequate impregnation with a curable adhesive resin and evacuation of air. The preferred woven textile is further designed with the required strength for pulling in-place the impregnated tubular liner 16 and for holding elevated internal pressures.

FIG. 2 further shows that the tubular liner 16 also comprises an impermeable film 20 made of a material impermeable to liquid. This film 20 is bonded to the inner surface of the inner jacket 18b as shown in FIG. 2. It will be understood that the impermeable film 20 is preferably made of a polymeric film impermeable to water. Although the impermeable film 20 may be made of a variety of polymeric films, it is more preferable to use a polymeric film made of a polymer selected from the group consisting of polyurethane, polyethylene, polyamide and synthetic rubbers, and any other elastomers of polymeric resins. The material composing the polymeric film preferably meets innocuousness requirements for contact with potable water.

It is worth mentioning that in another embodiment of the invention, the tubular liner 16 may advantageously comprise more than two jackets 18.

Therefore, after providing a tubular liner 16 as previously described, such a tubular liner 16 has to be impregnated with a curable adhesive resin 26 before its insertion in the host conduit 12. This is achieved by injecting the curable adhesive resin 26 in a void space 19 found between the two tubular jackets 18a, 18b, as shown in FIG. 2. The injection is preferably achieved by feeding the curable adhesive resin 26 with one or more injection needles 28 connected to a hose arrangement and a pump. The needle 28 allows for the injection of the curable adhesive resin 26 between the two tubular jackets 18a, 18b while maintaining the mechanical and physical integrity of the tubular liner 16 assembly.

The curable adhesive resin 26 used in the method of rehabilitation of the present invention is preferably prepared by mixing a resin and a hardener. According to a preferred embodiment, the element composing the curable adhesive resin 26 meets innocuousness requirements for contact with potable water. Examples of such curable resins are epoxy, polyurea, vinyl ester or any other suitable resin known to one skilled in the art.

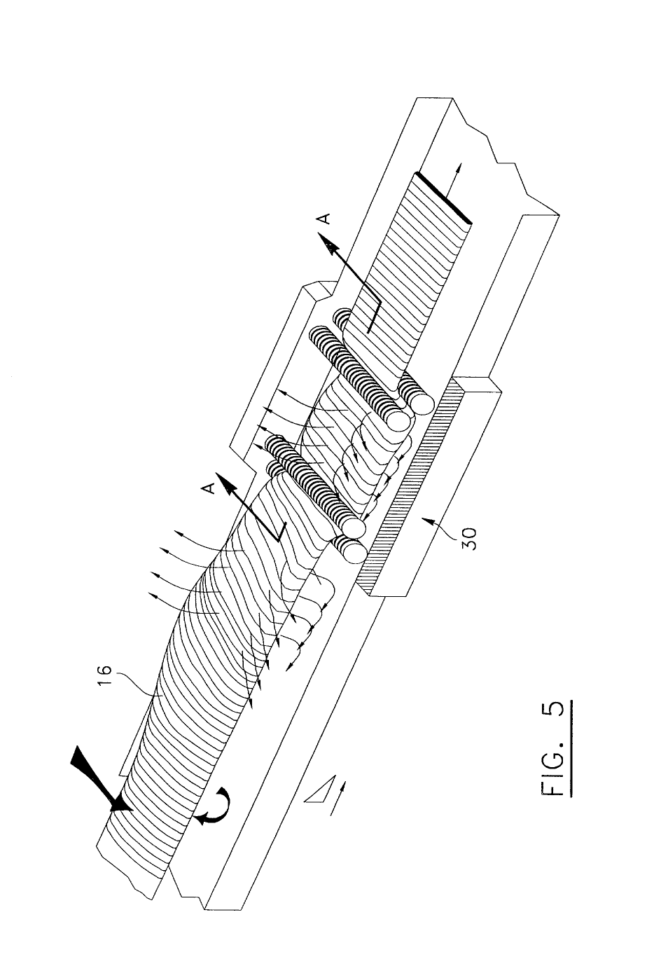

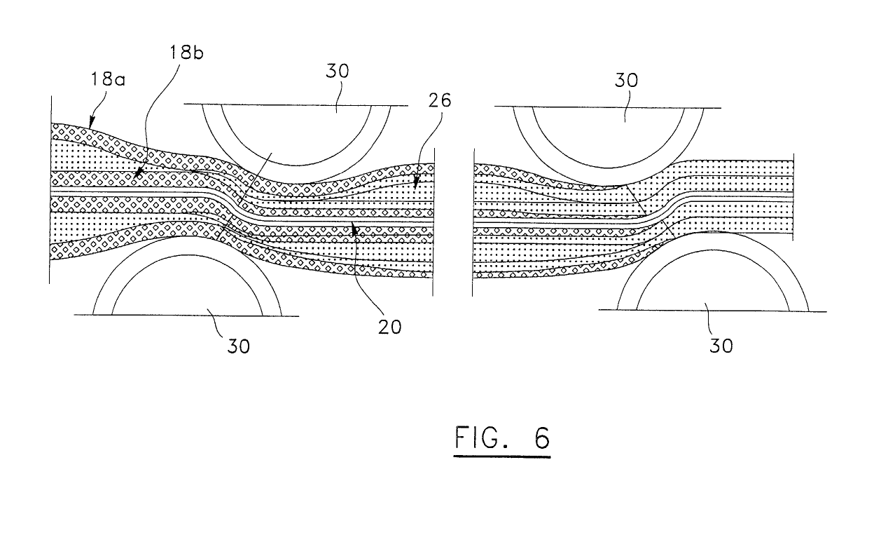

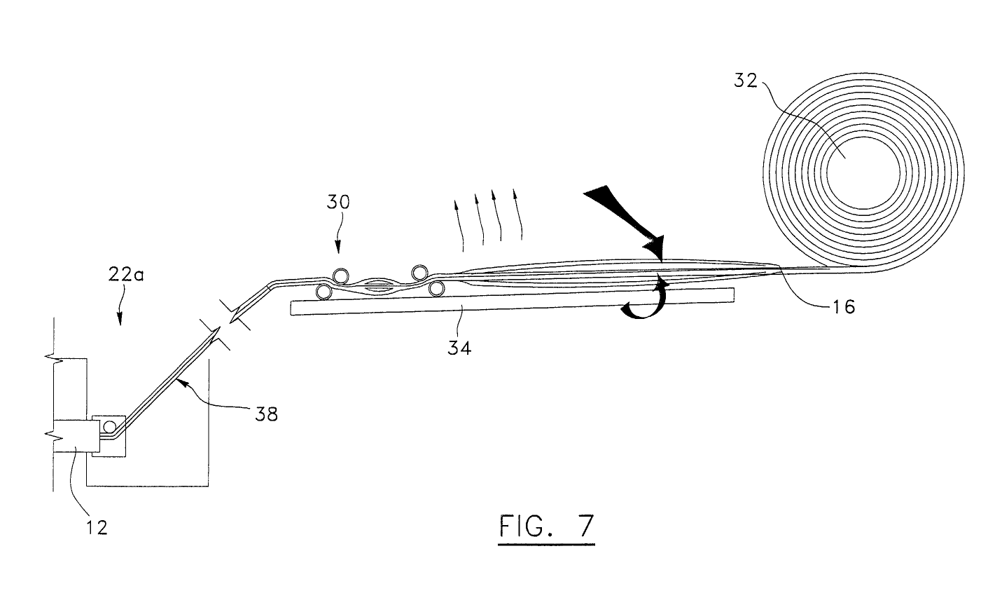

Turning now to FIGS. 5, 6 and 7, after injection of the curable adhesive resin 26 (as depicted by the thick black arrows in FIGS. 5 and 7), the tubular liner 16 is preferably conveyed towards a set of compression rollers 30 designed to press the tubular jackets 18a, 18b, as shown in FIG. 5 in conjunction with FIG. 6. This allows to substantially distribute evenly the curable adhesive resin 26 while displacing the air trapped in the void space 19 between the two tubular jackets 18a, 18b and within the two tubular jackets 18a, 18b, as shown by the thin arrows in FIGS. 5 and 7. The action of pressure, by the compression rollers 30, allows the curable adhesive resin 26 to flow from inside the space, between the two tubular jackets 18a, 18b, to the outside of the tubular liner 16. With the action of the compression rollers 30, the curable adhesive resin 26 impregnates the tubular jackets 18a, 18b. In other words, the curable adhesive resin 26 is substantially spread homogeneously through the tubular jackets 18a, 18b and substantially covers the outside surface of the tubular liner 16.

With the action of the compression rollers 30 and thanks to the presence of more than one jacket, the tubular liner 16 is substantially free from air bubbles that would diminish the mechanical performance of the tubular liner 16 and provides an even distribution of the curable adhesive resin 26 on the outside surface of the tubular liner 16. After impregnation, the tubular liner 16 is ready for insertion in the host conduit 12.

FIG. 7 is a general view of the preparation steps performed on the tubular liner 16 before its insertion into the conduit 12. The tubular liner 16 used may be made of two (2) concentric, tubular, plain weave polyester jackets 18a, 18b reinforced or not with fiberglass, KEVLAR™ or carbonaceous fiber, such as graphite fiber, with the inner jacket 18b bonded onto a polyurethane elastomer 20. Such tubular liner 16 is rolled flat onto a wheel support 32 at the end of a stainless steel table 34. The table 34 is preferably inclined to allow the excess adhesive 26 to flow off the table 34. At the other end of the table 34, there are preferably four (4) compression rollers 30 through which the tubular liner 16 shall pass. Still at the end of the table 34, the tubular liner 16 preferably passes through a sloped tunnel 38 to align the tubular liner 16 with the point of entry 22a of the host conduit 12 in the access pit. Advantageously, the table arrangement is preferably installed in a refrigerated compartment in order to slow the curing reaction between the components of the adhesive resin 26.

Referring back to FIG. 4, the tubular liner 16 is inserted in the host conduit 12 by preferably winching the tubular liner 16, attached to a cable 40, through the host conduit 12. The tubular liner 16 is inserted through the entry pit 22a and into the conduit 12 by pulling in place. The tubular liner 16 is pulled through the whole length of the host conduit 12.

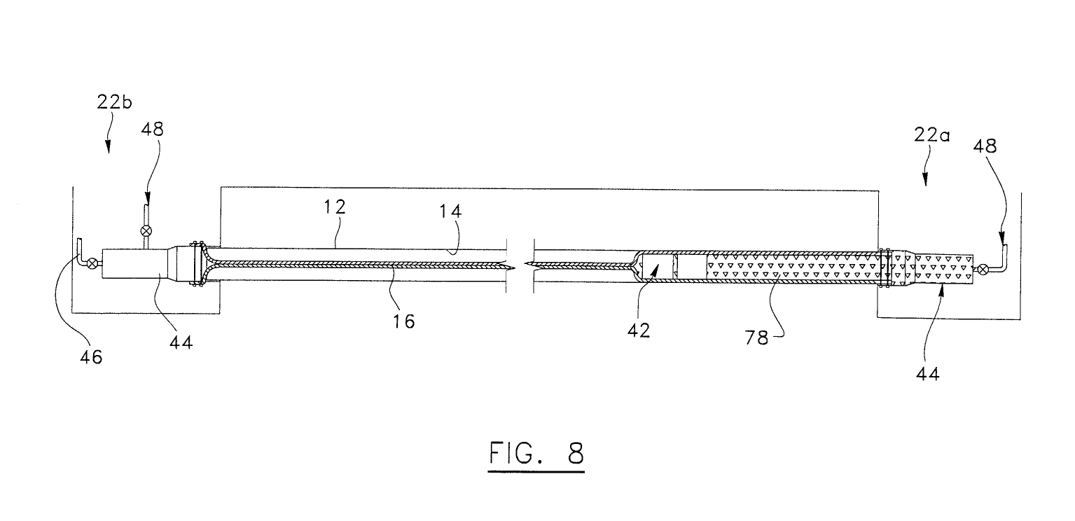

After the insertion of the liner 16 into the whole length of the conduit 12, the impregnated tubular liner 16 is resting flat on the bottom of the conduit 12 and must be applied against the inner wall 14 of the conduit 12. The shaping or the forming of the tubular liner 16 against the conduit's inner wall 14 is achieved by the effect of passing a shaping member 42 within the tubular liner 16, as shown in FIG. 8. Such a shaping member 42, which is commonly called a pig, is preferably pushed by pressurized water 78. Under this action, the tubular liner 16 extends outwardly and takes its natural cylindrical form. At the same time, the air which was present in the conduit 12 is removed from the space between the tubular liner 16 and the conduit's inner wall 14. The shaping of the tubular liner 16 also allows the distribution of the curable adhesive resin 26 in the cracks 70 of the conduit 12 and more importantly the cavities surrounding the penetrating threaded side connections of the corporation stops between the tubular liner 16 and the host conduit 12. The sealing and mechanical bonding between the lateral connections and the new pipe formed by the hardened tubular liner 16 constitutes a key advantage of the method of the present invention, making unnecessary the excavation at penetrating corporation stops, this excavation requirement being what makes the use of competing technologies such as insertion of deformed/reformed polyethylene much less attractive.

After the forming of the tubular liner 16, the curable adhesive 26 is cured in place. The curing of the curable adhesive resin 26 is preferably achieved by the effect of the passage of hot pressurised water through the tubular liner 16. The transfer of the heat from the water to the curable adhesive 26 allows the cross-linking reaction to take place, and thus the curing of the curable adhesive resin 26. The curing of the curable adhesive 26 provides rigidity and mechanical strength to the tubular liner 16. Furthermore, the curing of the adhesive resin 26 may advantageously bond the tubular liner 16 to the inner wall 14 of the host conduit 12.

In order to adequately achieve the forming step, and to allow for pressurised water to push the pig 42, and still to perform the curing of the adhesive resin 26, an inlet device 44a and an outlet device 44b are preferably respectively installed at the entry and exit ends of the tubular liner 16 once it has been pulled in place in the host conduit 12. As shown in FIG. 8, the inlet and outlet devices 44a, 44b are preferably attached to the host conduit 12 or held in place with fastening means such as holding collars. Furthermore, the outlet device 44b has a vent 46 with a valve at the extremity to allow for air, inside the tubular liner 16, to escape as the forming is taking place. While the forming is taking place, the air is replaced by water. Both, the inlet and outlet devices 44a, 44b are equipped with a water connection 48 with an isolation valve to allow the recirculation of water in the tubular liner 16 to maintain the desired temperature and better distribute the heat along the same.

In the process of inserting and forming and still, curing the composite tubular liner 16 in the host conduit 12, the service connections and corporation stops are completely blocked and overlapped by the tubular liner 16. The free flow of water through the service connections and the corporation stops is restored by opening these connections. The opening is preferably achieved with a remote controlled rotary grinder (not shown) that is inserted in the rehabilitated conduit 10 and activated by an operator with a handheld control and camera. The grinder is equipped with a drilling tool to allow the operator to create an opening in the tubular liner 16 at the precise location of the connection. Such drilling action does not affect the watertightness of the rehabilitated pipe 10 because the watertightness is preserved under by the cured adhesive 26 that surrounds the threaded cavities of the corporation stop and provides a tight bond with the tubular liner 16.

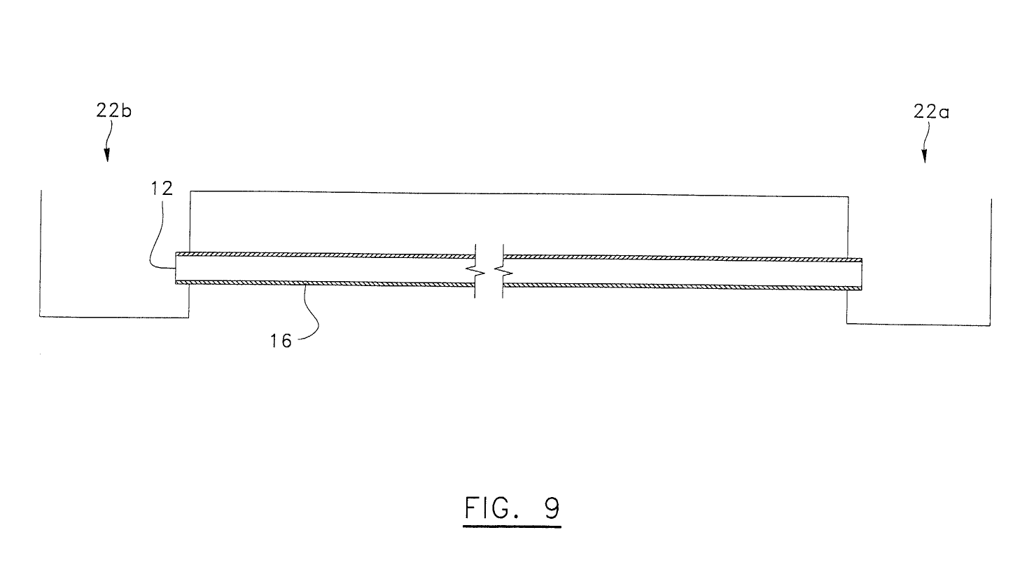

After opening the connections, the rehabilitated pipe 10 as shown in FIG. 9 is preferably subjected to disinfection through chlorination and put back in service as known in the art.

To sum up, the present invention proposes a method of rehabilitating a tubular conduit 12 having an inner wall 14 which comprises the steps of:

a) providing a tubular liner 16 as defined above;

b) injecting a curable adhesive resin 26 between the two tubular jackets 18a, 18b;

c) impregnating a curable adhesive resin 26 into the tubular jackets 18a, 18b;

d) inserting the tubular liner 16 of step c) into the conduit 12;

e) shaping the tubular liner 16 to conform to the inner wall 14 of the conduit 12; and

f) heating the curable adhesive resin 26 for rigidifying the tubular liner 16.

The method of the present invention may comprise prior to step b), a step of cleaning the inner wall 14 of the conduit 12.

According to a preferred embodiment of the invention, step c) preferably comprises the step of pressing the tubular jackets 18a, 18b. More preferably Step c) comprises the step of conveying the tubular liner 16 through a set of rollers 30.

According to a preferred embodiment, step d), comprises the step of pulling the tubular liner 16 into the conduit 12.

Also, step e) may comprise the steps of introducing into an entry end of the tubular liner 16 a shaping member 42, and moving the shaping member 42 from the entry end to an exit end of the tubular liner 16 for conforming the tubular liner 16 to the inner wall 14 of the conduit 12.

Step e) may further comprise the additional step of sending pressurized water through the entry end of the tubular liner 16 for moving the shaping member 42 towards the exit end of the tubular liner 16.

Step f) may comprise the step of sending pressurized hot water into the tubular liner 16 to cure the thermosetting adhesive. It will also be understood that steps e) and f) may be achieved simultaneously.

Finally, the method of the present invention may further comprise the step of recirculating the hot pressurized water in the tubular liner 16.

Thus, it is believed that the rehabilitation of a damaged conduit by the above proposed method with a tubular liner of the present invention makes it possible to meet several, even all of the desired characteristics for the rehabilitation of underground potable water lines and watermains, i.e. watertightness (no leakage under pressurized service), innocuousness, ease of installation (more rapidity and reliability than other methods), structural construction (for holding internal and external pressures), avoidance of excavation at the corporation stops (these are reopened with a remote controlled driller, the curable adhesive resin providing adhesion and sealing between the threaded connections of the corporation stops and the new conduit), and overall cost-effectiveness.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

What is claimed is:

1. A tubular liner for covering an inner wall of a conduit, the liner comprising:
at least two concentric tubular jackets made of a flexible material capable of being impregnated with a curable adhesive resin, said at least two tubular jackets including an outer jacket and an inner jacket; and
an impermeable film made of a material impermeable to liquid, bonded to an inner surface of the inner jacket.

2. A tubular liner according to claim 1, wherein the impermeable film is a polymeric film.

3. A tubular liner according to claim 2, wherein the polymeric film is made of a material selected from the group consisting of polyurethane, polyethylene, polyamide, and synthetic rubbers.

4. A tubular liner according to claim 1, wherein the flexible material is a woven textile.

5. A tubular liner according to claim 4, wherein the woven textile has a yarn density of about 1.1807 kg/m².

6. A tubular liner according to claim 1, wherein the woven textile is made of a material selected from the group consisting of polyester fiber, glass fiber or carbonaceous fiber.

7. A rehabilitated conduit comprising:
a tubular conduit with an inner wall; and
a liner covering said inner wall of the conduit, the liner comprising:
at least two concentric tubular jackets impregnated with a curable adhesive resin, said at least two jackets being bonded to each other and including an outer jacket and an inner jacket; and
an impermeable film made of a material impermeable to liquid, bonded to an inner surface of the inner jacket.

8. A rehabilitated conduit according to claim 7, wherein the conduit is a water conduit.

9. A rehabilitated conduit according claim 7, wherein the outer jacket is substantially bonded to the inner wall of the conduit.

10. A rehabilitated conduit according to claim 7, wherein the impermeable film is a polymeric film.

11. A rehabilitated conduit according to claim 10, wherein the polymeric film is made of a material selected from the group consisting of polyurethane, polyethylene, polyamide, and synthetic rubbers.

12. A rehabilitated conduit according to claim 7, wherein the flexible material is a woven textile.

13. A rehabilitated conduit according to claim 12, wherein the woven textile has a yarn density of about 1.1807 kg/m².

14. A rehabilitated conduit according to claim 13, wherein the woven textile is made of a material selected from the group consisting of polyester fiber, glass fiber or carbonaceous fiber.

15. A rehabilitated conduit according to claim 7, wherein the curable adhesive resin is a resin selected from the group consisting of epoxy resin, polyurea resin or vinyl ester resin.

16. A method of rehabilitating a tubular conduit having an inner wall, the method comprising the steps of:
a) providing a tubular liner as defined in claim 1;
b) injecting a curable adhesive resin between the at least two tubular jackets;
c) impregnating a curable adhesive resin into the tubular jackets;
d) inserting the tubular liner of step c) into the conduit;
e) shaping the tubular liner to conform to the inner wall of the conduit; and
f) heating the curable adhesive resin for rigidifying the tubular liner.

17. A method according to claim 16, comprising prior to step b), a step of cleaning the inner wall of the conduit.

18. A method according to claim 16, wherein step c) comprises the step of pressing the tubular jackets.

19. A method according to claim 18, wherein step c) further comprises the step of conveying the tubular liner through a set of rollers.

20. A method according to claim 16, wherein step d), comprises the step of pulling said tubular liner into the conduit.

21. A method according to claim 16, wherein step e) comprises the steps of introducing into an entry end of the tubular liner a shaping member, and moving said shaping member from said entry end to an exit end of the tubular liner for conforming the tubular liner to the inner wall of said conduit.

22. A method according to claim 21, wherein step e) comprises the additional step of sending pressurized water through the entry end of the tubular liner for moving the shaping member towards the exit end of the tubular liner.

23. A method according to claim 16, wherein step f) comprises the step of sending pressurized hot water into the tubular liner.

24. A method according to claim 16, wherein steps e) and f) are achieved simultaneously.

25. A method according to claim 16, further comprising the step of recirculating the hot pressurized water in the tubular liner.

26. A method according to claim 16, wherein the tubular conduit is a water conduit.
